(19) United States
(12) Patent Application Publication
(10) Pub. No.: US 2008/0006753 A1
(43) Pub. Date: Jan. 10, 2008

(54) Stand for notebooks

(75) Inventors: Antonio Campagnoli, Scandiano (Reggio Emilia) (IT); Francesco Morsiani, Scandiano (Reggio Emilia) (IT)

Correspondence Address: PYLE & PIONTEK;ATTN: THOMAS R. VIGIL, 221 N LASALLE STREET , ROOM 2036, ROOM 2036, CHICAGO, IL, 60601, US

(73) Assignee: RIOM SERVICES LIMITED, Dublin 4 (IE)

(21) Appl. No.: 11/823,967

(22) Filed: Jun. 28, 2007

(30) Foreign Application Priority Data
Jul. 4, 2006 (IE) 2006/0494

(51) Int. Cl. F16M 11/08

(52) U.S. Cl. 248/398

(57) ABSTRACT

The invention relates to a stand (1) suitable for easy viewing of a notebook display (1a). A rest element (2), an intermediary element (3) and an upper element (4) are reciprocally constrained by means of rotating constraints (2b and 4b). The variable inclination of the upper element (4) is obtainable by means of a support element (5) which, constrained to the said upper element can be fitted into a plurality of ribs or notches (7) present on one of the upper surface (3a) of the intermediary element (3).

The invention relates to a stand for notebooks.

The use of notebooks is increasingly commonplace nowadays, given the practicality of these electronic devices.

However, their use presents at least one drawback: since the geometric form of the said notebooks presents a flat resting surface in addition to a display surface which is perpendicular to the said resting surface, the view of the display, being nowadays usually a liquid crystal display, proves extremely inconvenient, forcing the user to maintain unusual positions, for several hours in order to focus vision down at the display, bending the neck or back more or less depending on the height of the user and the surface on which it is resting; if the notebook presented an inclined resting surface, then the display would prove higher than the resting surface and the view of the display would undoubtedly be much more efficient; even more so, obviously, if the said inclination were adjustable.

There are devices manufactured which are suitable to raise, by means of the inclination of the notebook, the display thereof with respect to the user's line of vision but they all present certain drawbacks such as the lack of adjustment features of particularly large dimensions which generate the obvious drawback of the reduced operative practicality or an extremely simplified construction and also this, although for different reasons, limits the height obtainable and therefore the practicality of the said devices.

Furthermore, the devices realised until now are not able to position the notebook at a height comparable to that of a desktop personal computer with the drawback that the user of the said notebooks suffer from backaches.

The main aim of the present invention is constituted of the possibility of supplying a stand featuring a dual function: comfortable use in the office and when traveling, when it is in the open position , and use without the risk of backaches when the said notebook is in the raised position, bringing the notebook display to a similar height of any desktop personal computer's display.

A further aim of the present invention is consisted of the possibility of rendering the support/stand essentially adaptable to notebooks produced by any manufacturer.

In particular, the stand for notebooks in question in the present invention is characterised by the fact that the said stand is constituted of the following elements:
a rest element featuring a flat lower surface;
an intermediary element constrained to the rest element at both opposite ends, the said double constraint being constituted of a first rotating constraint and a friction element;
an upper element constrained to the intermediary element by a second rotating constraint, the upper surface of the said upper element constituting a rest element for the notebook;
a support element interposed between the intermediary element and the upper element, the said constraint being constituted of a third rotating constraint positioned essentially on a lower surface of the said upper element;
a link element between the rest element, intermediary element and upper element, the said link element being essentially divided into an upper portion and lower portion, the said two portion s being reciprocally joined essentially in correspondence with the second rotating constraint.

This and other characteristics will better emerge from the detailed description that follows of a preferred embodiment, provided in the form of a non-limiting example, with reference to the accompanying drawings, in which:

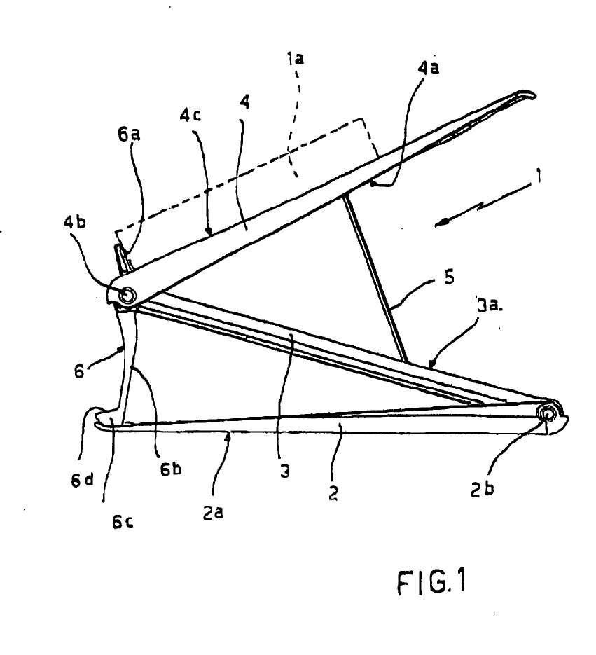

FIG. 1 shows a lateral view of the subject of the present invention is a ‘raised’ position;

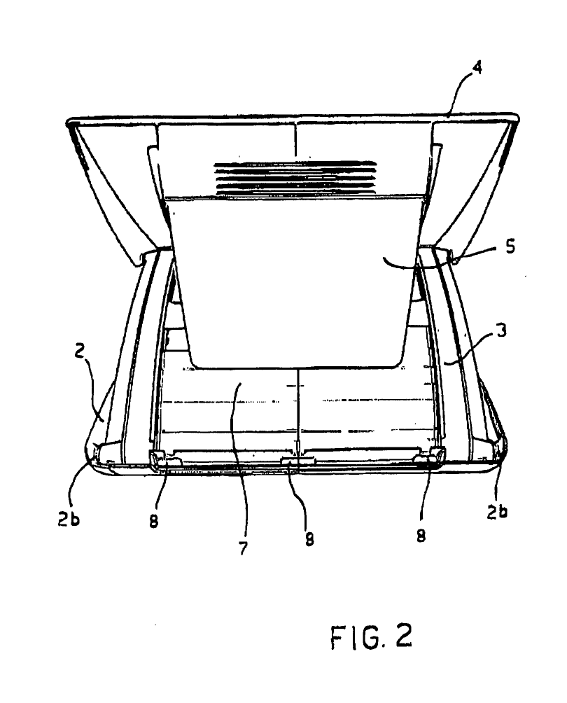

FIG. 2 shows a rear front view of the invention in the ‘raised’ position;

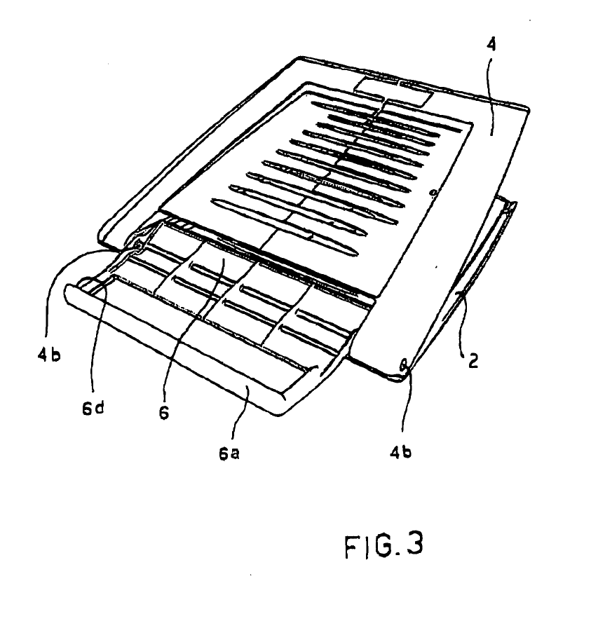

FIG. 3 shows the subject of the present invention in the ‘open’ position;

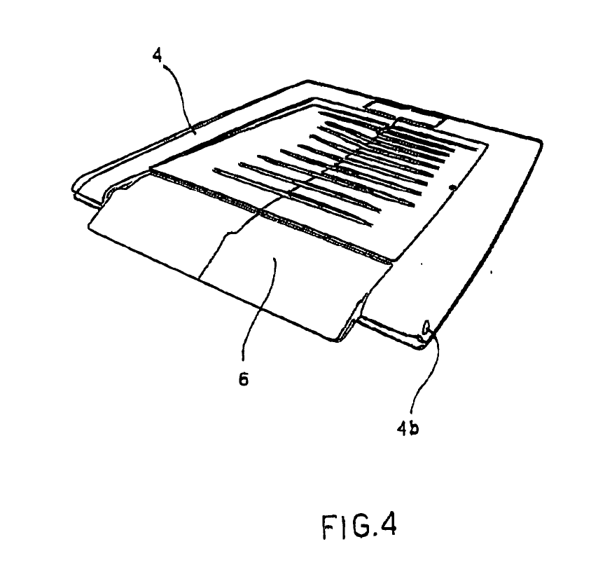

FIG. 4 shows an overview of the invention in the non-operative position, i.e. closed.

With reference to the drawings, 1 marks a stand, 1a marks a notebook and 2 marks a resting element.

2a marks the flat lower surface, or the resting surface, of the said stand.

An intermediary element 3 is connected underneath the rest element 2 by means of two rotating elements 2b each of which is positioned opposite the other in correspondence with the two lateral ends of the rest element 2.

The end of the intermediary element 3 opposite the end hearing the rotation element 2b is raised with respect to the rest element 2 by means of a link element 6 which is composed of an upper portion 6a and a lower portion 6b; the latter bears, at its lower end, a friction element 6c, which presents a configuration substantially corresponding to that of a groove featuring a crest 2c, the said groove and the said crest being obtained on an upper face of the said rest element 2 orthogonally to the orthogonal development of the stand 1. The link element 6 also features a relief 6d.

4 refers to an upper element which proves hinged to the intermediary element 3 by means of two second rotating constraints 4b. The said second rotating constraints also concern the link element 6.

The upper element 4 is raised with respect to the intermediary element 3 by means of the interposition, between the two said elements, of a support element 5 which appears constrained, in correspondence with its upper end, with the possibility of rotation, to a lower surface 4a whose surface is insertable, if desired, into one of a plurality of grooves or notches 7 obtained on an upper surface 3a and, extending in an essentially orthogonal manner to the essentially longitudinal development of the intermediary element 3, said ribbing or notches being suitable to fit a lower portion of the support element 5 in positions presenting various degrees of inclination of the upper element 4, given that the latter appears inclined when the stand 1 is in the open configuration.

When the said stand is in the operative configuration, the rest element 2, the intermediary element 3 and the upper element 4 are reciprocally positioned in such as way as to form an essentially Z-shaped configuration; on the other hand, when the stand 1 is not utilized the said stand presents a flattened configuration given that both the intermediary element 3 and the support element 5 are folded up into a horizontal position.

The intermediary element 3 bears, positioned on its lower part, three cableway holes 8.

All the elements constituting the stand 1 are realised in various kinds of materials, such as, for example, plastic materials, metal materials, such as, for example, aluminum, and possibility even cardboard. Obviously, only metal materials can resist high temperatures before catching fire and can, also, resist the temperatures that could develop when utilising old generation notebooks. In order to guarantee aeration for the notebook 1a, the whole surface of the stand 1 features grooving.

The functioning mode of the invention will now be described with reference to numbers indicated in the figures.

After resting the stand 1 on the desired resting surface by means of the flat lower surface 2a, one proceeds by partially lifting the intermediary element 3, making it rotate, with respect to the rest element 2, around the first rotation elements 2b.

The partial lifting of the upper element 4 is maintained in position by means of the insertion of the support element 5 into one of the grooves or notches 7 present on the surface of the intermediary element 3, as shown in FIG. 3, corresponding to an ‘open’ configuration of the stand 1 in which the notebook resting on the upper surface 4c is practically touching the surface on which the stand is resting. In the said configuration the hands of the user operate in notably comfortable conditions since the notebook 1 is resting directly on the work surface and the said notebook is prevented from slipping on the said work surface by the relief 6d which the link element 6 features. The ‘open’ configuration thus obtained will show the notebook monitor 1 to the user raised by a number of centimetres thereby preventing the said user's line of visioning moving downwards with consequent curving of the back and neck.

In order to make the stand 1 assume the ‘raised’ configuration, one rotates the link element 6 around the second rotating constraints 4b in order to move both the lower portion 6b thereof so that it corresponds with the friction element 6c inside the groove featuring a crest 2c and the upper portion 6a, so that the said portion overhangs the upper surface 6c.

At the same time, the support element 5 is positioned, in a more or less inclined manner depending on which of the grooves or notches 7 are occupied by the lower part of the said support element.

In this way the notebook 1a ends up resting on the upper surface 4c with the display perfectly aligned with respect to the user's line of vision and it is also prevented from slipping towards the bottom of the upper element 4 thanks to the presence of the upper portion 6a.

For use in the open configuration, it is necessary to utilise the additional mouse and keyboard of the traditional kind.

When the use of the notebook is complete, one can return the stand 1 in the flat positioned by folding the upper element 4 onto the intermediary element 3, once the support element 5 has been rotated and then folding up and fitting the said intermediary element inside the intermediary element 3 once the link element 6 has been rotated, thereby obtaining a flat configuration of the stand 1.

The presence of the cableway holes 8 allows, for example, the notebook's mouse, keyboard and power leads to be fastened.

We claim:

1. A stand (1) for notebooks (1a), characterized by the fact that the said stand is constituted of the followings elements: a rest element (2) featuring a flat lower surface (2a); an intermediary element (3) constrained to the rest element (2) at both opposite ends, the said double constraint being constituted of a first rotating constraint (2b) and a friction element (6c); an upper element (4) constrained to the intermediary element (3) by a second rotating constraint (4b), the upper surface (4c) of the said upper element constituting a rest element for the notebook (1a); a support element (5) interposed between the intermediary element (3) and the upper element (4), the said constraint being constituted of third rotating constraint positioned essentially on a lower surface (4a) of the said upper element; a link element (6) between the rest element (2), intermediary element (3) and upper element (4), the said link element being essentially divided into an upper portion (6a) and lower portion (6b), the said two portion s being reciprocally joined essentially in correspondence with the second rotating constraint (4b).

2. A stand according to claim 1, characterized by the fact that the friction element (6c) has a configuration essentially corresponding to that of a groove featuring a-crest (2c).

3. A stand according to claim 1, characterized by the fact that an upper surface (3a) features a plurality of grooves or notches (7) extending in an essentially orthogonal manner to the longitudinal development of the intermediary element (3), said ribbing or notches being suitable to fit a lower portion of the support element (5) in positions presenting various degrees of inclination of the upper element (4).

4. A stand according to claim 1, characterized by the fact that the first upper portion (6a) constitutes a shoulder element beneath the notebook (1a).

5. A stand according to claim 1, characterized by the fact that there are cableway holes (8) obtained in the said stand suitable for fastening, for example, the leads for the additional mouse and keyboard and accessories in general and for the notebook's power supply.

6. A stand according to claim 1, characterized by the fact that the stand can assume an “open” or “raised” or a “closed” configuration, the first thereof being suitable to guarantee that the user's hands operate in comfortable conditions, the second thereof being suitable to guarantee a lifting of the notebook (1a) to a similar height to that of a desktop personal computer. The third configuration is suitable for the transportation of the stand (1) when completely folded up.

7. A stand according to claim 1, characterized by the fact that the “closed” configuration thereof envisages the reciprocal folding up of the rest element (2), the intermediary element (3), the upper element (4) and the support element (5) the said reciprocal folding up being designed to minimize the thickness of the stand (1).
